(19) United States
(12) Patent Application Publication
(10) Pub. No.: US 2015/0267831 A1
(43) Pub. Date: Sep. 24, 2015

(54) Valve Stem Cover and System

(71) Applicant: Caterpillar Inc., Peoria, IL (US)

(72) Inventors: Matthew Beschorner, Plainfield, IL (US); Salik Syed, Aurora, IL (US); John Ferraz, Romeoville, IL (US); Mikhail Sorokin, Naperville, IL (US)

(73) Assignee: Caterpillar Inc., Peoria, IL (US)

(21) Appl. No.: 14/660,505

(22) Filed: Mar. 17, 2015

Related U.S. Application Data
(60) Provisional application No. 61/954,873, filed on Mar. 18, 2014.

(51) Int. Cl. F16K 27/12

(52) U.S. Cl. CPC F16K 27/12

(57) ABSTRACT

A valve cover includes a first cover portion, second cover portion, web, and a plurality of bolt holes formed therein. The first cover portion has a first shape. The second cover portion has a second shape that is different from the first shape. The web connects the first cover portion to the second cover portion. The valve cover has a long axis disposed along the first cover portion, web and second cover portion. A first bolt hole of the plurality of bolt holes is offset from a remainder of the plurality of the bolt holes.

### CROSS REFERENCE TO RELATED APPLICATIONS

This application claims priority to U.S. Provisional Application Ser. No. 61/954,873, filed on Mar. 18, 2014, titled “VALVE STEM COVER AND SYSTEM,” the disclosure of which is incorporated herein by reference in its entirety.

### TECHNICAL FIELD

This patent disclosure relates generally to a cover for a stem in hydraulic systems and, more particularly, to an anti-spin cover for valve stems in the hydraulic system.

### BACKGROUND

In many mechanical systems, forces acting upon the various components of the system tend to unscrew or otherwise disassemble the system. To counteract these forces, bolts are generally tightened to particular torque values, locking washers and adhesive formulations are used and the like. Hydraulic systems are particularly susceptible to disassembly due to the relatively high pressures, fluid velocities, and lubricity of hydraulic fluid.

In a main valve housing of a hydraulic system, a series of valves may be placed into the housing to control one or more hydraulic actuators. Hydraulic actuators may include hydraulic motors that convert fluid power into shaft rotational power, hydraulic cylinders that convert fluid power into translational motion, or other hydraulic actuators known in the art. If these valves stems rotate in the housing in an uncontrolled manner, damage may result. Unfortunately, conventional hydraulic systems do not include an anti-spin device to resist free rotation.

In these conventional main valve housings, it is also a problem that the valve stems are interchangeable even though they function differently. Unfortunately, due to the different function of the valve stems, improper placement of adjacent valve stems may cause damage or improper performance of the main valve housing and/or the hydraulic actuators controlled thereby.

Accordingly, there is a need for an improved hydraulic system to address the problems described above and/or problems posed by other conventional approaches.

### SUMMARY

The foregoing needs are met, to a great extent, by aspects of the present disclosure, wherein in one respect a hydraulic system is provided that in some aspects addresses the problems posed by other conventional approaches.

An aspect relates to a valve cover. The valve cover includes a first cover portion, second cover portion, web, and a plurality of bolt holes formed therein. The first cover portion has a first shape. The second cover portion has a second shape that is different from the first shape. The web connects the first cover portion to the second cover portion. The valve cover has a long axis disposed along the first cover portion, web and second cover portion. A first bolt hole of the plurality of bolt holes is offset from a remainder of the plurality of the bolt holes.

Another aspect pertains to a main valve housing. The main valve housing includes a first valve stem, second valve stem, and valve cover. The first valve stem has a first valve stem shape. The second valve stem has a second valve stem shape that is different from the first valve stem shape. The valve cover includes a first cover portion, second cover portion, web, and a plurality of bolt holes formed therein. The first cover portion has a first cover portion shape corresponding to the first valve stem shape. The second cover portion has a second cover portion shape corresponding to the second valve stem shape. The web connects the first cover portion to the second cover portion. The valve cover has a long axis disposed along the first cover portion, the web and the second cover portion. A first bolt hole of the plurality of bolt holes is offset from a remainder of the plurality of the bolt holes.

Yet another aspect relates to a machine having a main valve housing. The main valve housing includes a first valve stem, second valve stem, and valve cover. The first valve stem has a first valve stem shape. The second valve stem has a second valve stem shape that is different from the first valve stem shape. The valve cover includes a first cover portion, second cover portion, web, and a plurality of bolt holes formed therein. The first cover portion has a first cover portion shape corresponding to the first valve stem shape. The second cover portion has a second cover portion shape corresponding to the second valve stem shape. The web connects the first cover portion to the second cover portion. The valve cover has a long axis disposed along the first cover portion, the web and the second cover portion. A first bolt hole of the plurality of bolt holes is offset from a remainder of the plurality of the bolt holes.

There has thus been outlined, rather broadly, certain aspects of the disclosure in order that the detailed description thereof herein may be better understood, and in order that the present contribution to the art may be better appreciated. There are, of course, additional aspects that will be described below and which will form the subject matter of the claims appended hereto.

In this respect, before explaining at least one example in detail, it is to be understood that the disclosure is not limited in its application to the details of construction and to the arrangements of the components set forth in the following description or illustrated in the drawings. The disclosed device and method is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the various aspects. It is important, therefore, that the claims be regarded as including such equivalent constructions insofar as they do not depart from the spirit and scope of the various aspects.

### BRIEF DESCRIPTION OF THE DRAWINGS

FIG. 1 is a top view of an exemplary cover disposed on a main valve housing, according to an aspect of the disclosure.

FIG. 2 is a top view of a portion of the main valve housing without the cover, according to an aspect of the disclosure.

FIG. 3 is a perspective view of the portion of the main valve housing without the cover, according to an aspect of the disclosure.

FIG. 4 is a partial cross sectional perspective view of the portion of the main valve housing with the cover, according to an aspect of the disclosure.

FIG. 5 is a cross sectional view 5-5 of the portion of the main valve housing with the cover, according to an aspect of the disclosure.

FIG. 6 is a cross sectional view 6-6 of the portion of the main valve housing with the cover, according to an aspect of the disclosure.

FIG. 7 is a cross sectional view 7-7 of the portion of the main valve housing with the cover, according to an aspect of the disclosure.

FIG. 8 is a perspective view of the cover, according to an aspect of the disclosure.

FIG. 9 is a top view of the cover, according to an aspect of the disclosure.

FIG. 10 is a bottom view of the cover, according to an aspect of the disclosure.

FIG. 11 is a side view of the cover, according to an aspect of the disclosure.

FIG. 12 is an end view of the cover, according to an aspect of the disclosure.

### DETAILED DESCRIPTION

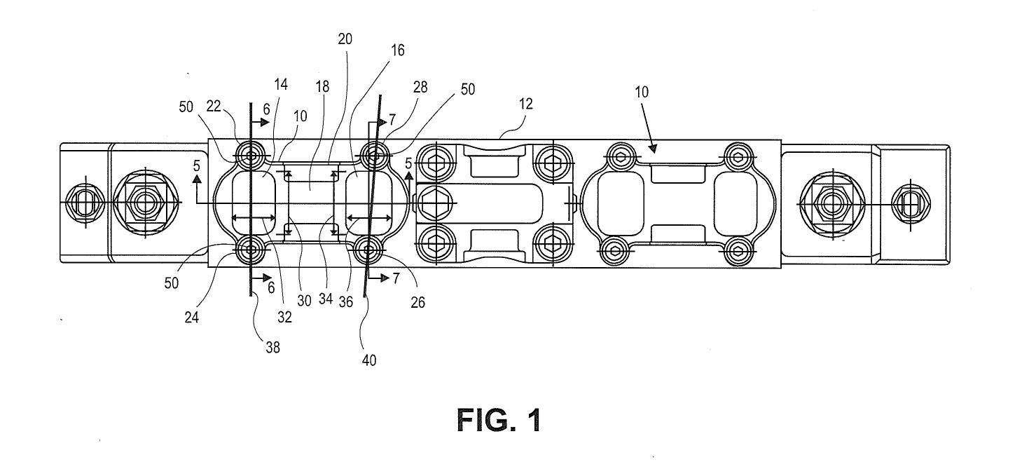

FIG. 1 is a top view of an exemplary cover 10 disposed on a main valve housing 12, according to an aspect of the disclosure. As is generally known, valve housings may be integral to the operation of any suitable machine. Examples of suitable machines include those with one or more hydraulic actuators. More particularly, suitable machines may embody a fixed or mobile machine that performs some type of operation associated with an industry such as mining, construction, farming, transportation, or another industry known in the art. For example, a suitable machine may be an earth moving machine such as an excavator, a dozer, a loader, a backhoe, a motor grader, a dump truck, or another earth moving machine. The main valve housing 12 may house valves configured to actuate an implement and/or drive system, for example. In the following description of the cover 10, a variety of features are described that aid in orienting the cover 10, that provide visual cues to speed assembly, that help to facilitate proper assembly of the main valve housing 12, that protect and secure components of the main valve housing 12, as well as additional benefits disclosed herein.

As shown in FIG. 1, the cover 10 includes a first cover portion 14, a second cover portion 16, a web 18, a flange 20, and a plurality of bolt holes 22, 24, 26, and 28. The first and second cover portions are formed to define a stem receiving cavity configured to receive a portion of the stems. In one example, the cover portions are formed by stamping process that displaces the cover material to be recessed below the general cover surface. The first cover portion 14 includes a length 30 and a width 32. The second cover portion 16 also includes a length 34 and a width 36. In general, the first cover portion 14 and the second cover portion 16 are distinguished from one another by at least one of their shapes, sizes, color, dimensions such as respective length and width. In a particular example shown in FIG. 1, the width 32 is relatively less than the width 36 in order to distinguish the first cover portion 14 from the second cover portion 16. In one example the stems are made from a stock of cylindrical material which has planar surfaces machined therein to form the bearing surfaces of a differential length. By having different widths, the first cover portion 14 is seen as a relatively narrow rectangle whereas the second cover portion 16 is seen as relatively more square than the first cover portion 14. This difference is easily detected by an assembly or servicing technician.

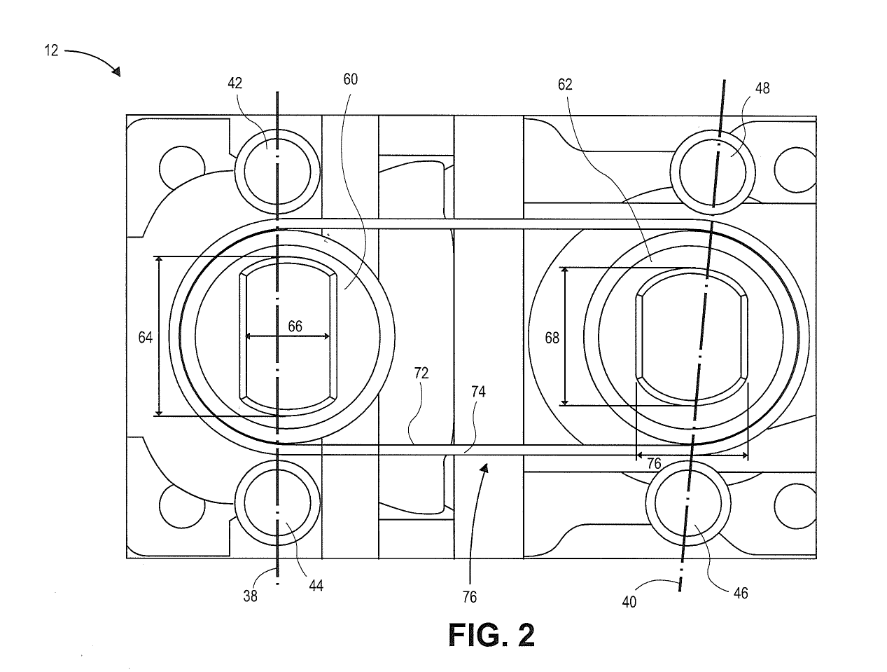

The web 18 is disposed between the first cover portion 14 and the second cover portion 16 and interconnects the two. The flange 20 is disposed about the perimeter of the first cover portion 14, web 18, and second cover portion 16 and is configured to provide a structure through which the bolt holes 22-28 are formed therein such as, e.g., by a boring process. As shown in FIG. 1, the bolt holes 22-28 are arranged about the flange 20 such that there is a unique solution to the orientation of the cover 10 on the main valve housing 12. In the particular example shown, the bolt holes 22 and 24 lay along a line 38 that is perpendicular to a long axis of the cover 10 while a line 40 passing through the bolt holes 26 and 28 is offset from perpendicular to the long axis of the cover 10. In addition or alternatively, the bolt hole 28 may be offset from the bolt hole 22. In another words, at least one of the bolt holes can be offset in either direction or both from the nearest adjacent bolt hole, i.e., for example, bolt hole 28 may be offset from bolt hole 26 and/or offset from bolt hole 22. In this manner, another visual cue is provided to the technician to aid in orientation of the cover 10. This helps speed assembly of the main valve housing 12. This arrangement of the bolt holes 22-28 also prevents the cover 10 from being incorrectly oriented and secured to the main valve housing 12 because only the correct orientation places the bolt holes 22-28 in cooperative alignment with a corresponding plurality of threaded bores 42-48 shown in FIG. 2. As such, only the correct orientation of the cover 10 on the main valve housing 12 allows for a plurality of bolts 50 to secure the cover 10 to the main valve housing 12.

FIG. 2 is a top view of a portion of the main valve housing 12 without the cover 10, according to an aspect of the disclosure. As shown in FIG. 2, the main valve housing 12 includes a first valve stem 60 and a second valve stem 62. To provide the technician with a visual cue for proper assembly, the first valve stem 60 is visually distinguished from the second valve stem 62 in similar manner as the portions of the cover. For example, the first valve stem 60 includes a length 64 and a width 66 and the second valve stem 62 includes a length 68 and a width 70. In a manner similar to the first cover portion 14 and the second cover portion 16, the width 66 may be relatively less than the width 70 to provide the visual cue. Optionally, the length 64 may be relatively greater than the length 68 to further heighten the distinguishing visual characteristics. As further described herein, these and other physical differences between the first valve stem 60 and the second valve stem 62 may be translated to the cover 10. In this manner the first cover portion 14 may accept and/or engage the first valve stem 60 (but not the second valve stem 62) and the second cover portion 16 may accept and/or engage the second valve stem 62 (but not the first valve stem 60).

Also shown in FIG. 2, the main valve housing 12 includes a seat 72 for an O-ring 74. In response to the O-ring 74 being disposed between the cover 10 and the main valve housing 12, a seal 76 is formed. As further shown in FIG. 2 and also referring to FIG. 1, the threaded bores 42 and 44 lay along the line 38 and the threaded bores 46 and 48 lay along the line 40. That is, each of the bolt holes 22-28 is disposed in cooperative alignment with corresponding ones of the threaded bores 42-48. Again, this asymmetric arrangement of the bolt holes 22-28 and the threaded bores 42-48 allows for only one solution to the orientation of the cover 10 on the main valve housing 12.

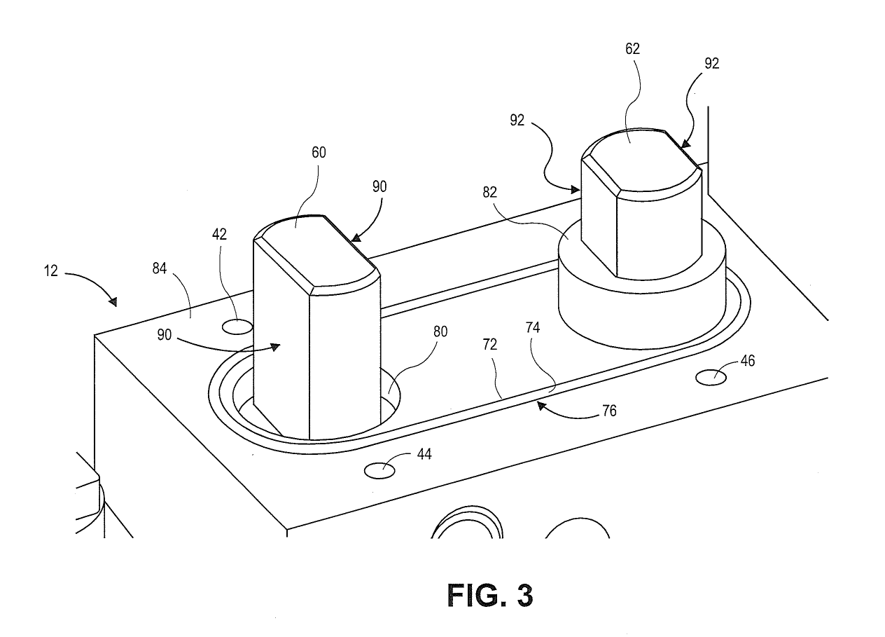

FIG. 3 is a perspective view of the portion of the main valve housing 12 without the cover 10, according to an aspect of the disclosure. As shown in FIG. 3, the first valve stem 60 includes a shoulder 80 and the second valve stem 62 includes a shoulder 82. In order to provide yet another visual cue to the technician, the shoulder 80 is disposed relatively further down the first valve stem 60 than the shoulder 82 on the second valve stem 62. When assembled, the shoulder 80 may be disposed relatively below a surface 84 whereas the shoulder 82 may be disposed relatively above the surface 84. It is a further advantage of this physical difference between the first valve stem 60 and the second valve stem 62 that this difference may also be translated to the cover 10 so that first cover portion 14 may accept and/or engage the first valve stem 60 (but not the second valve stem 62) and the second cover portion 16 may accept and/or engage the second valve stem 62 (but not the first valve stem 60).

Also shown in FIG. 3, the first valve stem 60 includes a pair of bearing surfaces 90 and the second valve stem 62 includes a pair of bearing surfaces 92. During installation of the first valve stem 60 and the second valve stem 62, the respective bearing surfaces 90 and bearing surfaces 92 facilitate the application of torque on the first valve stem 60 and the second valve stem 62 via a wrench, socket, or other such tool. It is an advantage of some aspects that the distance between the bearing surfaces 90 is less than the distance between the bearing surfaces 92. As a result, a different tool or differently sized tool is used to apply torque to the first valve stem 60 as compared to the tool used to apply torque to the second valve stem 62. Here again, the technician is provided a cue to aid in identification and therefore prevent misassembly.

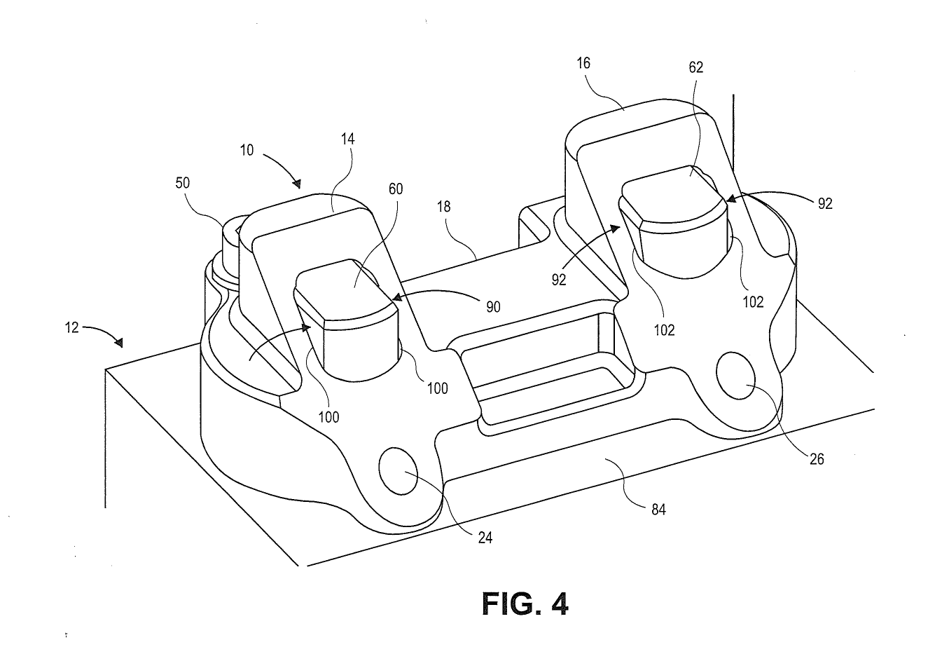

FIG. 4 is a partial cross sectional perspective view of the portion of the main valve housing 12 with the cover 10, according to an aspect of the disclosure. As shown in FIG. 4, the first cover portion 14 includes a pair of bearing surfaces 100 and the second cover portion 16 includes a pair of bearing surfaces 102. The bearing surfaces 100 are configured to engage the bearing surfaces 90 and prevent rotation of the first valve stem 60. In this manner, the cover 10 prevents the first valve stem 60 from being rotated. Similarly, the bearing surfaces 102 are configured to engage the bearing surfaces 92 and prevent rotation of the second valve stem 62. In this manner, the cover 10 prevents the second valve stem 62 from being rotated.

In addition, the pair of bearing surfaces 100 is configured to prevent the first cover portion 14 from being movably disposed along the second valve stem 62. In the particular example shown, the distance between the pair of bearing surfaces 100 is less than the width of the second valve stem 62. However, more generally, the pair of bearing surfaces 100 are sized or shaped to preclude entry of the second valve stein 62 into the first cover portion 14. Similarly, the pair of bearing surfaces 102 is configured to prevent the second cover portion 16 from being movably disposed along the first valve stem 60. For example, the pair of bearing surfaces 102 are sized or shaped to preclude entry of the first valve stem 60 into the second cover portion 16. In this manner, the bearing surfaces 100 and 102 and/or the respective shapes of the first and second cover portions 14 and 16 prevent the cover 10 from being disposed in an incorrect alignment on the main valve housing 12. Also shown in FIG. 4, the shape of the first cover portion 14 generally conforms to the shape of the first valve stem 60 and therefore differs from the shape of the second cover portion 16 which generally conforms to the second valve stem 62.

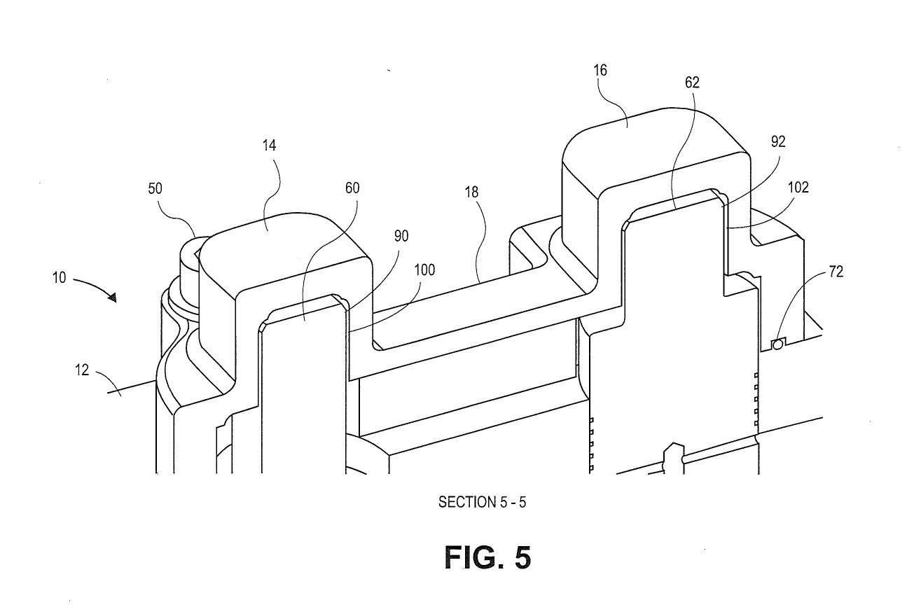

FIG. 5 is a cross sectional view 5-5 of the portion of the main valve housing 12 with the cover 10, according to an aspect of the disclosure. As shown in FIG. 5, the bearing surfaces 100 are configured to engage the bearing surfaces 90 and prevent rotation of the first valve stem 60 and the bearing surfaces 102 are configured to engage the bearing surfaces 92 and prevent rotation of the second valve stem 62. In this manner, the cover 10 prevents the first valve stem 60 and the second valve stem 62 from being rotated.

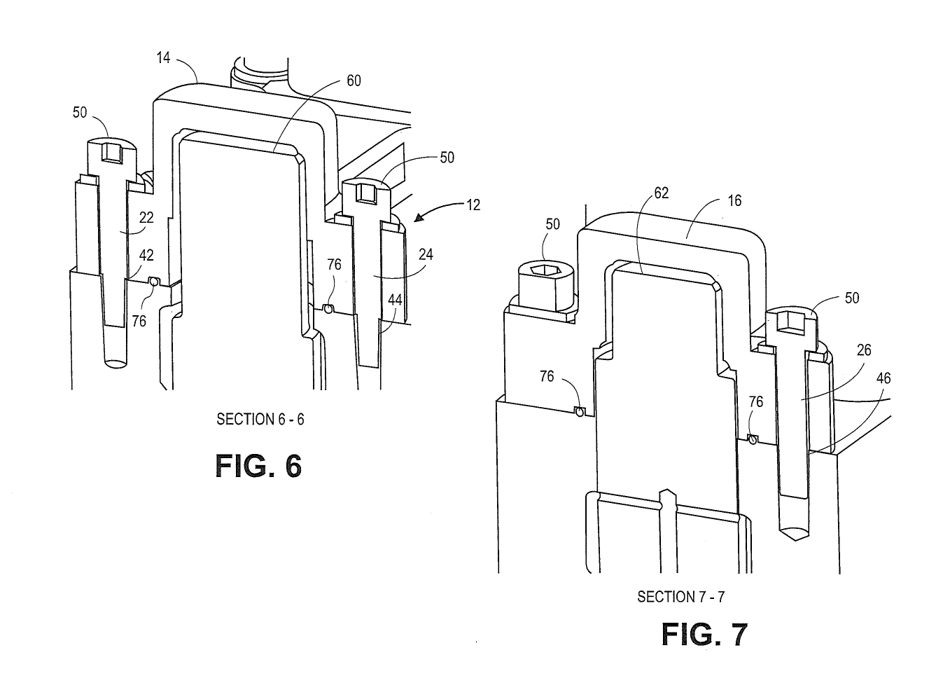

FIGS. 6 and 7 are cross sectional views 6-6 and 7-7 of the portion of the main valve housing 12 with the cover 10, according to an aspect of the disclosure. As shown in FIG. 6, the cross sectional view 6-6 that cuts perpendicularly across the long axis of the cover 10 passes through a respective centerline of bolt holes 22 and 24. Again, the bolt holes 22 and 24 are in cooperative alignment with the threaded bores 42 and 44 to facilitate securing the cover 10 to the main valve housing 12. However, to generate the unique alignment solution for securing the cover 10 on the main valve housing 12, FIG. 7 shows that the cross sectional view 7-7 cuts perpendicularly across the long axis of the cover 10 does not pass through a respective centerline of bolt holes 26 and 28 at the same time. Instead, the cross sectional view 7-7 passes through the centerline of bolt hole 26. Of note, the bolt holes 26 and 28 are in respective cooperative alignment with the threaded bores 46 and 48 to facilitate securing the cover 10 to the main valve housing 12.

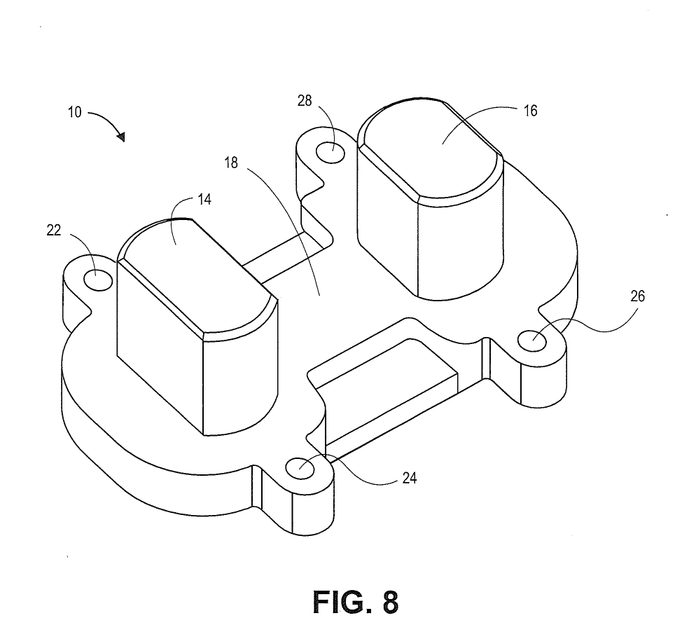

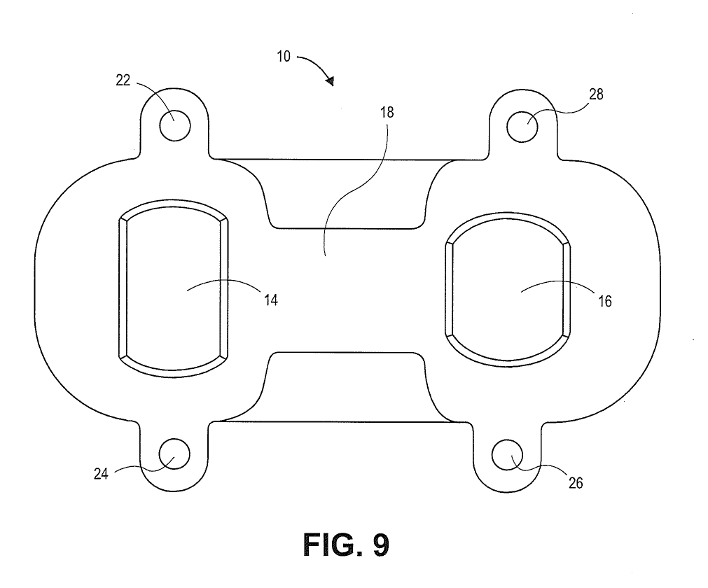

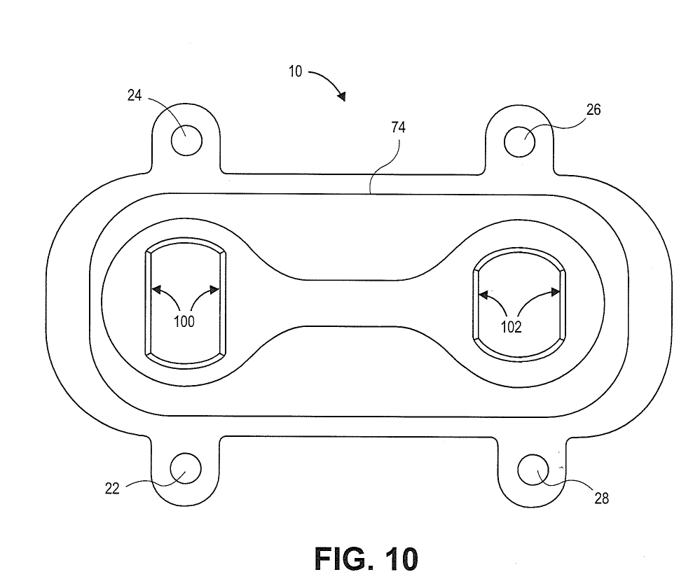

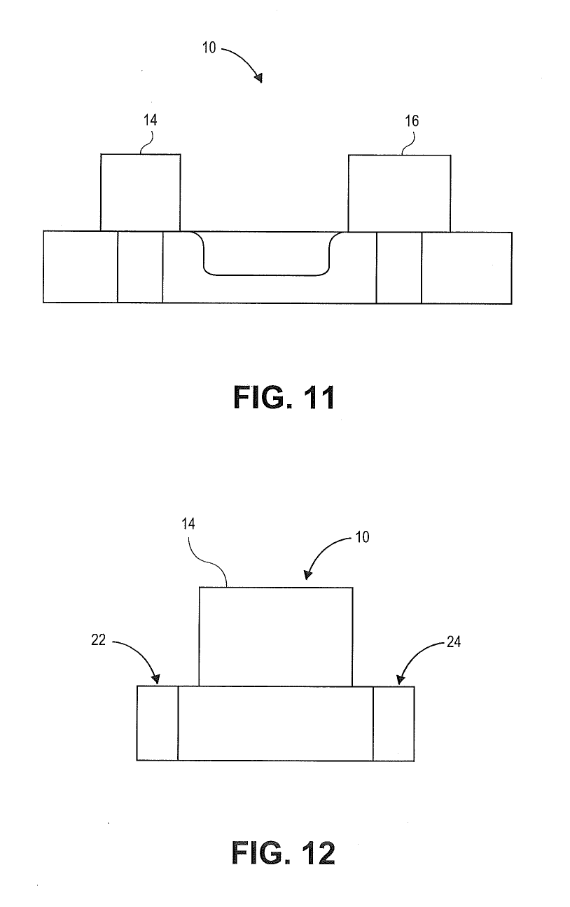

FIG. 8 is a perspective view of the cover 10, according to an aspect of the disclosure. FIG. 9 is a top view of the cover 10, according to an aspect of the disclosure. FIG. 10 is a bottom view of the cover 10, according to an aspect of the disclosure. FIG. 11 is a side view of the cover 10, according to an aspect of the disclosure. FIG. 12 is an end view of the cover 10, according to an aspect of the disclosure.

### INDUSTRIAL APPLICABILITY

The present disclosure may be applicable to any machine including a hydraulic system containing two or more hydraulic actuators. Aspects of the disclosed cover for the main valve housing of the hydraulic system may promote operational improvements in productivity of assembly and maintenance of the hydraulic system. The cover can be particularly useful for adjacent valve stems that have similarly looking end profiles when looking along the longitudinal axis of the stems.

Applicants discovered that a conventional approach of providing a cover that can be oriented in more than one direction increased assembly errors and, therefore, decreased overall assembly performance. By providing a plurality of visual cues to technicians during assembly, assembly errors were reduced or eliminated. For example, by providing a cover that can only be secured to the main valve assembly in one orientation and having the cover manifest visual similarities to a correctly assembled main valve assembly, the technician is provided with a template or reminder of the proper assembly. Then, at each step in assembly, physical differences in the shape of the valve stems serve as additional visual cues for proper assembly. Having different tools configured to only engage one valve stem or the other again reinforces these visual cues. Furthermore, various structures of the cover allow only the proper valve stem to enter the corresponding cover portion. As such, if an assembly error were to occur, the inability of the cover to fit on the valve stems is configured to provide the technician with yet another cue to remedy the assembly.

According to an aspect of the disclosure shown in FIG. 1, the differences in the shapes of the first cover portion 14 and the second cover portion 16 provide a visual cue to the technician about the proper assembly positions of the first valve stem 60 and the second valve stem 62. In addition, according to an aspect of the disclosure shown in FIG. 1, the offset arrangement of the bolt holes 22-28 create a unique orientation solution that provides the technician with a visual clue as to the proper orientation.

These visual cues speed assembly by indicating to the technician what the proper assembly procedure is so that the valve stems and cover can be immediately oriented and assembled without trial and error. Furthermore, if an assembly error is initially made, the unique shape and single possible orientation of the cover 10 prevents final assembly until the error is corrected.

According to an aspect of the disclosure shown in FIG. 3, the cover protects and secures the first valve stem 60 and the second valve stem 62. For example, the first valve stem 60 and the second valve stem 62 are subject to repeated high and low pressure cycling of hydraulic fluid pressures that, conventionally, tend to cause valve stems to rotate. The bearing surfaces of the cover 10 prevent this rotation of the valve stems by engaging the bearing surfaces of the valve stems. In addition, left uncovered, the valve stems would be subject to high flow rates of hydraulic fluid that may create turbulent flow about the valve stems. The turbulent flow may also act to rotate the valve stems. By providing the cover 10, the first valve stem 60 and the second valve stem 62 are protected from the turbulent flow.

In one application the valve housing can be a single valve housing for at least four valves, such as, e.g., four independent metering valve (IMV) stems configured to control fluid flow between a main pump of the machine, a tank of the machine, and a hydraulic actuator. For example, the valve stems may be referred to individually as a cylinder-to-tank head end (CTHE) metering valve stem, a pump-to-cylinder head end (PCHE) metering valve stem, a pump-to-cylinder rod end (PCRE) metering valve stem, and a cylinder-to-tank rod end (CTRE) metering valve stem. To this end, the left cover (referring to FIG. 1) may correspond to valve stems associated with a first chamber of the hydraulic actuator, e.g., the CTHE metering valve stem and PCHE metering valve stem, and the right cover may correspond to valve stems associated with a second chamber of the hydraulic actuator, e.g., the PCRE metering valve stem and CTRE metering valve stem.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified. The many features and advantages of the various aspects are apparent from the detailed specification, and thus, it is intended by the appended claims to cover all such features and advantages that fall within the true spirit and scope of the aspects. Further, since numerous modifications and variations will readily occur to those skilled in the art, it is not desired to limit the aspects to the exact construction and operation illustrated and described, and accordingly, all suitable modifications and equivalents may be resorted to, falling within the scope of the various aspects.

We claim:

1. A valve cover, comprising:
a first cover portion having a first shape;
a second cover portion having a second shape that is different from the first shape;
a web connecting the first cover portion to the second cover portion, the valve cover having a long axis disposed along the first cover portion, the web and the second cover portion; and
a plurality of bolt holes formed therein, wherein a first bolt hole of the plurality of bolt holes is offset from a remainder of the plurality of the bolt holes.

2. The valve cover according to claim 1, further comprising:
a pair of first cover portion bearing surfaces disposed in the first cover portion configured to engage a pair of first valve stem bearing surfaces of a first valve stem to prevent the first valve stem from rotating.

3. The valve cover according to claim 2, further comprising:
a pair of second cover portion bearing surfaces disposed in the second cover portion configured to engage a pair of second valve stem bearing surfaces of a second valve stem to prevent the second valve stem from rotating.

4. The valve cover according to claim 3, wherein the first shape corresponds to the first valve stem.

5. The valve cover according to claim 4, wherein the second shape corresponds to the second valve stem.

6. The valve cover according to claim 3, wherein the pair of first cover portion bearing surfaces is configured to prevent the first cover portion from being movably disposed along the second valve stem.

7. The valve cover according to claim 3, wherein the pair of second cover portion bearing surfaces is configured to prevent the second cover portion from being movably disposed along the first valve stem.

8. The valve cover according to claim 1, further comprising:
a flange disposed about a perimeter of the valve cover, the plurality of bolts holes being disposed through the flange.

9. A main valve housing comprising:
a first valve stem having a first valve stem shape;
a second valve stem having a second valve stem shape that is different from the first valve stem shape; and
a valve cover, comprising:
a first cover portion having a first cover portion shape corresponding to the first valve stem shape;
a second cover portion having a second cover portion shape corresponding to the second valve stem shape;
a web connecting the first cover portion to the second cover portion, the valve cover having a long axis disposed along the first cover portion, the web and the second cover portion; and
a plurality of bolt holes formed therein, wherein a first bolt hole of the plurality of bolt holes is offset from a remainder of the plurality of the bolt holes.

10. The main valve housing according to claim 9, further comprising:
a pair of first cover portion bearing surfaces disposed in the first cover portion configured to engage a pair of first valve stein bearing surfaces of a first valve stem to prevent the first valve stem from rotating.

11. The main valve housing according to claim 10, further comprising:
a pair of second cover portion bearing surfaces disposed in the second cover portion configured to engage a pair of second valve stem bearing surfaces of a second valve stem to prevent the second valve stem from rotating.

12. The main valve housing according to claim 11, wherein the pair of first cover portion bearing surfaces is configured to prevent the second valve stem from being inserted therein.

13. The main valve housing according to claim 11, wherein the pair of second cover portion bearing surfaces is configured to prevent the first valve stem from being inserted therein.

14. The main valve housing according to claim 9, further comprising:
a flange disposed about a perimeter of the valve cover, the plurality of bolts holes being disposed through the flange.

15. A machine comprising the main valve housing according to claim 9.

16. The machine according to claim 15, wherein the machine includes a single hydraulic actuator corresponding to the first valve stem and the second valve stem.

17. The machine according to claim 15, wherein the main valve housing includes a second cover for a third and fourth valve stem, the machine includes a first hydraulic actuators having a first chamber corresponding to the first valve stem and the second valve stem, and a second chamber corresponding to the third valve stem and the fourth valve stem.
